(19) United States
(12) Patent Application Publication
(10) Pub. No.: US 2009/0139836 A1
(43) Pub. Date: Jun. 4, 2009

(54) Apparatus and Process for Unscrambling and Aligning Bulk Plastic Containers

(75) Inventor: Lino Lanfranchi, Collecchio (IT)

Correspondence Address: YOUNG & THOMPSON, 209 Madison Street, Suite 500, ALEXANDRIA, VA, 22314, US

(73) Assignee: LANFRANCHI S.R.L., CELLECCHIO (IT)

(21) Appl. No.: 11/795,692

(22) PCT Filed: Nov. 21, 2005
(86) PCT No.: PCT/EP05/12434

§ 371 Date: Jul. 20, 2007

(30) Foreign Application Priority Data
Jan. 21, 2005 (IT) PR2005A000001

(51) Int. Cl. B65G 47/24

(52) U.S. Cl. 198/373

(57) ABSTRACT

The invention finds application in the field of bottling and particularly relates to an apparatus (1) for unscrambling and aligning bulk plastic containers (2). It is comprised of a substantially circular collecting hopper (6), a plurality of container cradle pockets (7) arranged in a circular ring (7a) outside and concentric with the hopper (6) and delimited by an outer retaining wall (5). At least one aperture (5a) is formed in said wall (5), for a plurality of pick-up means (3) to extract the containers (2) in a substantially radial direction. One or more inspection devices (11) determine the orientation of the container (2) and communicate it to the pick-up means (3), which rotates the container and orients it with the neck up before releasing it.

This invention relates to an apparatus and a process for unscrambling and aligning bulk containers.

Such apparatus is used in the bottling field, more precisely upstream from plastic bottle or container handling lines, as it allows to unscramble and align the containers being fed therein, e.g. in an in-feed hopper, in a random, i.e. unscrambled fashion.

These are industrial apparatus, therefore they are supposed to provide higher and higher production rates, which means that they must produce a larger number of unscrambled containers with no interruption.

Various types of apparatus have been developed in the art to solve the above problem.

Typical apparatus utilize mechanical means, such as gravity cradles or hoppers, for redressing the containers (conveniently laid into cradling pockets).

U.S. Pat. No. 5,439,093 discloses an apparatus wherein the bottles (or containers) are loaded and carried by an elevator into a pre-orienting hopper, whose function is to arrange and unscramble the bottles in two possible configurations (with the neck oriented in one direction or the other) so that they can be carried by a conveyor belt from said hopper to a container pick up and position inspection station.

After being picked up by one of said pick-up means, the container has its position checked by the inspection means and, as the pick-up carousel rotates, the container is suitably rotated to its optimal configuration when it reaches the belt conveyor for aligned and unscrambled bottles.

This invention differs from that disclosed in U.S. Pat. No. 5,439,093 in that containers are extracted by suitable pick-up means in a direction that is substantially radial with respect to the circular arrangement of containers, which are disposed over a ring of cradling pockets or trays, concentric with the loading hopper.

Once it has been picked up, the container is suitably rotated to its optimal position, to be released onto an output belt.

Another difference consists in the position of the unscrambling carousel which, in the above mentioned patent, has its axis of rotation parallel to the pick-up and rotation axis of each container, whereas in this patent, the pick-up means are mounted to a turret placed with its axis vertical to the axis of rotation of each container rotating means.

Radial pick up, which occurs through suitable circumferential apertures formed in the outer retaining wall of the ring of cradling pockets may be advantageously carried out by suction pick-up means.

Hence, containers of any shape may be picked up, unlike the above mentioned patent in which, due to the type of bottle hooking means, picking up is limited to bottles having a substantially symmetric or sufficiently regular shape.

In this invention, the layout of pick-up means may be preferably set by locating several turrets along the apparatus, thereby affording a higher production rate, i.e. daily output of unscrambled and aligned bottles.

Also, unlike the above mentioned patent, in which two inspection means were provided in the unscrambling station, in this invention each station may preferably have one inspection means, which is preferably placed in the hopper and not in the rotating unit, so that the extraction means may be earlier informed of the rotation direction to be used.

This will conveniently reduce idle times before signal arrival, thereby affording a higher rotation, pick-up and alignment rate.

The object of this invention is to provide an aligning and unscrambling apparatus which considerably increases the unscrambling rate, thanks to a novel radial bottle pick-up arrangement.

These objects and advantages are achieved by the apparatus for unscrambling and aligning bulk containers and the process obtained thereby, both according to this invention, which are characterized as defined in the annexed claims.

These and other features will be more apparent from the following description of a few embodiments, which are shown by way of example and without limitation in the accompanying drawings, in which:

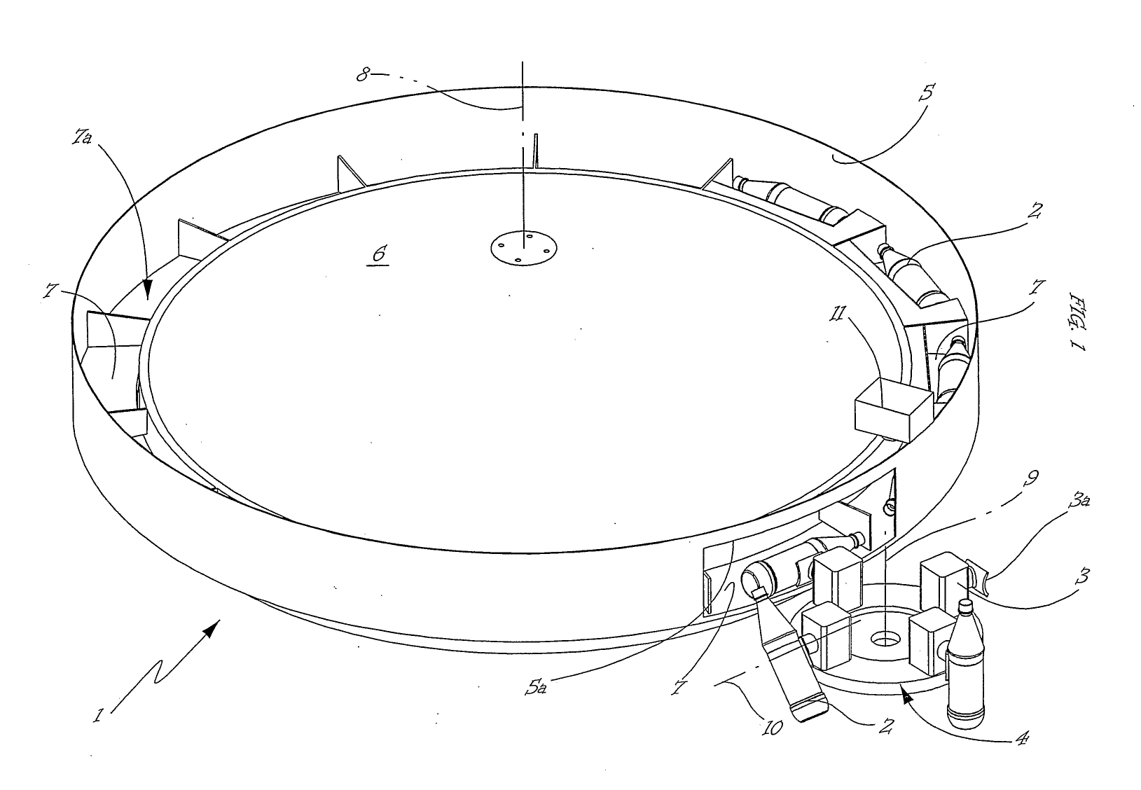

FIG. 1 is a top perspective view of an apparatus for unscrambling and aligning general containers, according to this invention;

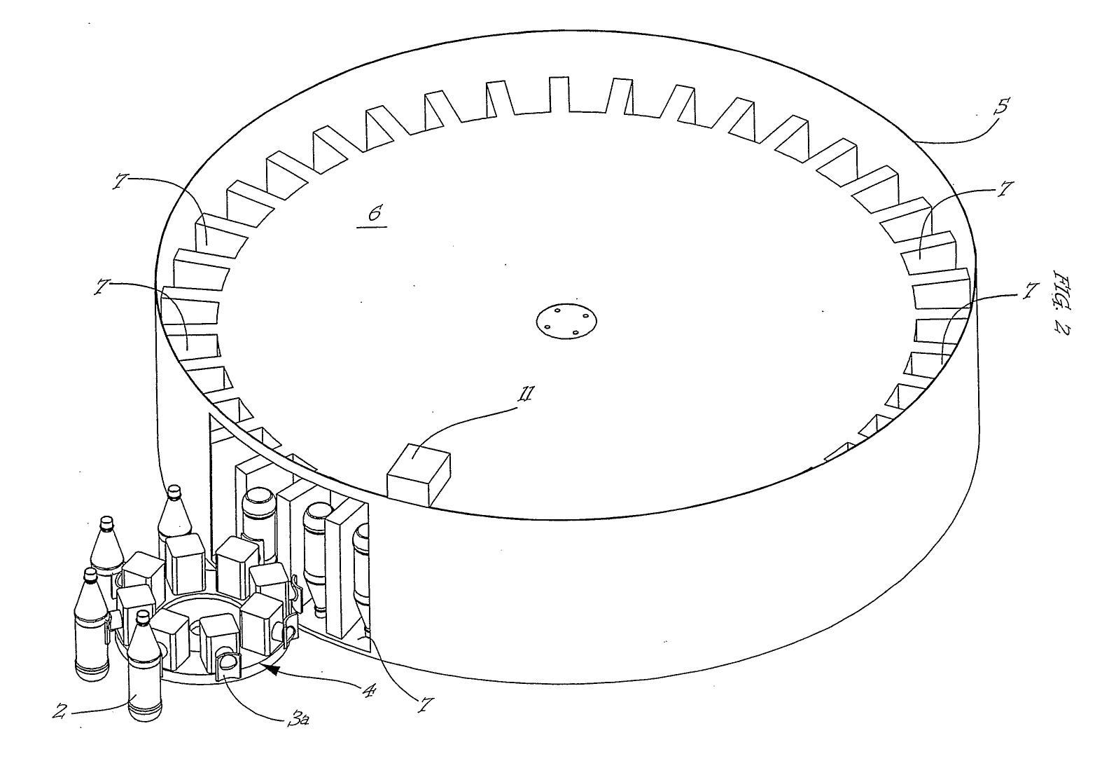

FIG. 2 is a top perspective view of the apparatus according to a second embodiment;

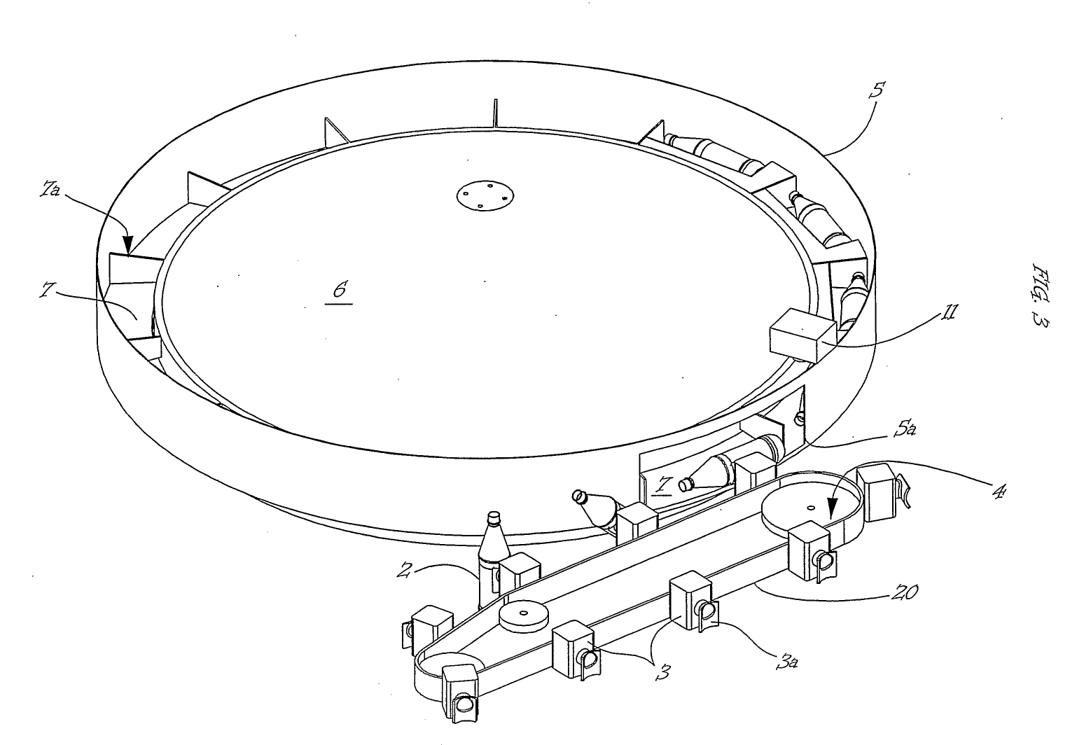

FIG. 3 is still the same perspective view of the inventive apparatus according to a further embodiment.

Referring to FIG. 1, 1 generally designates an apparatus for unscrambling and aligning bulk containers 2, which comprises a substantially circular hopper 6 for collecting containers 2; a plurality of cradling pockets 7 for containers 2, arranged in such a manner as to form a circular ring 7a, outside and concentric with the hopper.

The cradling pockets 7 are in turn delimited by an outer wall 5, concentric with the cradling pockets 7.

At least one aperture 5a is formed along the outer wall 5, which allows a plurality of pick-up means 3 to extract the container 2 when it faces the aperture 5a.

As mentioned above, several pick-up means 3 are mounted on one or more turrets 4, the latter being located along the periphery of the wall 5 and at each aperture 5a.

The apparatus 2 further has one or more devices 11 for checking the orientation of the container 2 position; in this example, the checking apparatus 11 is a camera which determines if the bottle in the pocket 7 is oriented in one direction or the other, and which is placed above the pocket 7 preceding the aperture 5a through which the container 2 is picked up.

As described above, the pick-up means 3 extracts the container 2 facing the corresponding aperture 5a, from the cradling pocket 7; such extraction occurs in a substantially radial direction.

The pick-up means 3 is, for example, a sucker 3a, wherein negative pressure is generated by a known pneumatic source, which is powered through the hollow column of the rotating turret.

The sucker that forms the pick-up means may rotate about its own horizontal axis through 90 or 180°, depending on the embodiment of the apparatus, as shown below.

Mechanical pick-up means, e.g. grippers, may be used instead of suckers.

The hopper 6 is rotated about its vertical axis 8 so that the containers 2 are pushed against the periphery of said hopper and transferred into the cradling pocket 7.

The hopper 6 may preferably, but without limitation, have a conical inner surface, to allow the containers 2 to fall into the pockets 7.

The ring 7a of pockets 7 may rotate either in a direction opposite the rotation of the hopper 6 or in the same direction as the latter.

In this case, i.e. if both have the same rotation direction, they can rotate synchronously and make the same or a different number of revolutions.

The aperture 5a is at least as wide as the cradling pocket 7 and/or the container 2 to be extracted.

The cradles or pockets 7 may advantageously have a fast replacement system, to receive different container formats, which adds versatility to the apparatus.

The pick-up means 3 is preferably a suction-operated device but, in a possible variant embodiment, not shown, the pick-up means 3 may be a container 2 gripping jaw device.

In another embodiment, not shown, the inspection device 11 may be also placed outside the ring of pockets 7: in this case, position reading will only occur when the pick-up means 3 has already extracted the container 2.

Referring to FIG. 2, the pockets extend vertically to receive bottles in the standing position either neck up or neck down.

In this case, the bottles may be either properly oriented and need no further rotation by the pick-up means or, be oriented neck down, whereby the pick-up means shall only rotate them through 180°.

Referring to FIG. 3, a further embodiment of the pick-up means will be now described, which is implemented as a conveyor belt 20 with a plurality of suckers attached thereon, which may rotate about their own horizontal axis.

In short, in the process of this invention, the apparatus 1 first places the containers 2 in the cradling pockets 7, which are arranged in a ring 7a, concentric with the hopper 6 and extracts the containers 2 by a pick-up unit 4 consisting of several pick-up means 3, in a substantially radial direction with respect to the arrangement and rotation direction of the containers 2 in the cradling pockets 7.

After extraction, the pick-up means 3 rotates and suitably orients the container 2 according to the rotation axis 10 of the means 3.

Such rotation is performed within the time during which the turret 4 carries the means 3 from the extraction position to the releasing position (generally by a belt, air or other similar arrangement); the turret 4 rotates relative to its own axis 9.

Therefore, the rotation of the container is only determined when the container 2 has had its position checked by the orientation monitoring device 11.

The pockets 7 may be fixed or replaceable, as a function of the shapes and sizes of the containers.

1-22. (canceled)

23. Apparatus for unscrambling and aligning bulk plastic containers (2), characterized in that it comprises:
a. a substantially circular hopper (6) for collecting the containers (2), which consists of an outer wall (5) and a flat or conical bottom;
b. a plurality of pockets (7) for containers (2) arranged in a circular ring (7a) inside and concentric with the hopper (6) between the bottom and the outer wall (5);
c. at least one aperture (5a) formed in the outer wall (5);
d. a plurality of container pick-up means (3) mounted on one or more rotating or translating transport devices (4) placed at each aperture (5a);
e. one or more devices (11) for checking the orientation of the container (2);
the pick-up means (3) extracts the container (2) from the pocket (7) at the corresponding aperture (5a) and rotates it to orient it neck up; such extraction being substantially radial with respect to the arrangement of the container (2) in the ring (7a) of pockets (7).

24. An apparatus as claimed in claim 23, characterized in that the bottom of the hopper (6) and the pockets are rotated about their vertical axis (8) so that the containers (2) are pushed against the periphery of said hopper, i.e. against the cradling pockets.

25. An apparatus as claimed in claim 23, characterized in that the bottom of the hopper is fixed and the pockets move in a circular path.

26. An apparatus as claimed in claim 23, characterized in that the hopper (6) has a conical inner surface to allow the containers (2) to fall against the periphery of said hopper (6).

27. An apparatus as claimed in claim 23, characterized in that the circular ring (7a) of pockets (7) rotates in a direction opposite to that of the hopper (6).

28. An apparatus as claimed in claim 23, characterized in that the circular ring (7a) rotates in the same direction as the hopper (6).

29. An apparatus as claimed in claim 23, characterized in that the circular ring (7a) and the hopper (6) rotate synchronously, and make the same number of revolutions.

30. An apparatus as claimed in claim 23, characterized in that the circular ring (7a) and the hopper (6) rotate synchronously, and make different numbers of revolutions.

31. An apparatus as claimed in claim 23, characterized in that the pockets have either a horizontal or a vertical extension, to maintain the containers in lying or standing positions.

32. An apparatus as claimed in claim 23, characterized in that the aperture (5a) is at least as wide as the cradling pocket (7) and/or the container (2) to be extracted.

33. An apparatus as claimed in claim 23, characterized in that the pick-up means (3) is a container (2) sucking device.

34. An apparatus as claimed in claim 23, characterized in that the pick-up means (3) is a mechanical or pneumatic container (2) grasping device.

35. An apparatus as claimed in claim 23, characterized in that the inspection device (11) is preferably a shape reading camera or a photocell.

36. An apparatus as claimed in claim 23, characterized in that the inspection device (11) is placed above the ring (7a) of cradling pockets (7).

37. An apparatus as claimed in claim 23, characterized in that the inspection device (11) is placed outside the ring (7a) and reads the position of the container (2) when the pick-up means (3) has completed its extraction step.

38. An apparatus as claimed in claim 23, characterized in that the pockets (3) are replaceable as a function of the shape and size of containers.

39. A process for unscrambling and aligning bulk containers (2) in a hopper from which the containers (2) are extracted in a substantially radial direction with respect to their position in a plurality of pockets (7); said pockets (7) being arranged in a circular ring (7a), inside and concentric with a hopper (6), in which said containers (2) are dropped in a random fashion, characterized in that the container (2) is rotated and suitably positioned after being extracted from the pocket (7).

40. A process as claimed in claim 39, characterized in that containers (2) are extracted when, during rotation of the ring (7a), they come before apertures (5a) formed along a wall outside and concentric with the ring (7a).

41. A process as claimed in claim 39, characterized in that the extraction means (3) rotates the container (2) in the required direction of rotation in response to the signal transmitted by the corresponding inspection device (11).
